(19) United States
(12) Patent Application Publication
(10) Pub. No.: US 2025/0191318 A1
(43) Pub. Date: Jun. 12, 2025

(54) GENERATING REALISTIC AND DIVERSE SIMULATED SCENES USING SEMANTIC RANDOMIZATION FOR UPDATING ARTIFICIAL INTELLIGENCE MODELS

(71) Applicant: NVIDIA Corporation, Santa Clara, CA (US)

(72) Inventors: Matthew TREPTE, San Francisco, CA (US); Jack Yusong ZHANG, San Jose, CA (US); Gordon GRIGOR, San Francisco, CA (US)

(73) Assignee: NVIDIA Corporation, Santa Clara, CA (US)

(21) Appl. No.: 18/532,272

(22) Filed: Dec. 7, 2023

(51) Int. Cl. G06T 19/20; G06T 7/70; G06T 13/40; G06V 10/60; G06V 20/70

(52) U.S. Cl. CPC G06T 19/20; G06T 7/70; G06T 13/40; G06V 10/60; G06V 20/70; G06T 2219/2004

(57) ABSTRACT

In various examples, systems and methods are disclosed relating to generating realistic and diverse simulated scenes of people for updating/training artificial intelligence models. A configuration file can be received that that specifies randomization for a semantic layer of a model for a scene. A distribution can be sampled according to the randomization to select data for the semantic layer of the model. The scene can be generated to include the model having the data selected for the semantic layer. The scene, including the model, can be rendered to generate an image for updating a neural network.

### BACKGROUND

Artificial intelligence models, including vision-based neural networks, can be updated/trained using sets of images and corresponding ground-truth labels. Although synthetic training images may be utilized in situations where real-world training data is impossible or impractical to obtain, conventional approaches for synthetically generating training images fail to incorporate characteristics that may be present in the real world, preventing artificial intelligence models updated/configured on that data from accurately generalizing to real-world images or video.

### SUMMARY

Embodiments of the present disclosure relate to systems and methods for generating realistic and diverse simulated scenes with people for updating/training artificial intelligence models. The present disclosure provides techniques for generating synthetic training images by simulating environments that include people. Models representing people, objects, and/or environments may include semantic layers upon which variations in texture, color, materials, and patterns may be applied to provide greater degrees of diversity even when using a limited set of three-dimensional (3D) assets. Conventional approaches for generating synthetic datasets often lack sufficient realism, particularly those that include images of simulated people.

In addition to incorporating semantic layers to increase variation and realism, additional techniques may be utilized to increase realism in simulated training data. For example, physical simulations of objects in the environment may be performed, including simulated gravity or other forces, or simulated collisions between objects. In another example, animations may be applied to different 3D assets to provide additional realism and variation between simulated training images. The techniques described herein can be utilized to generate training sets that greatly surpass the realism and diversity of images generated using conventional techniques.

At least one aspect relates to a processor. The processor can include one or more circuits. The one or more circuits can receive a configuration (e.g., via a configuration file) that specifies a level or degree of randomization for a semantic layer of a model (e.g., a three-dimensional model) for a scene. The one or more circuits can sample a distribution according to the randomization to select data (e.g., texture, material, color, pattern) for the semantic layer of the model. The one or more circuits can generate the scene (e.g., 3D environment) including the model having the data selected for the semantic layer. The one or more circuits can render the scene including one or more representations of the model to generate an image for updating (e.g., training, establishing, configuring) a neural network.

In some implementations, the one or more circuits can generate a scene that includes a model of an environment (e.g., a pre-generated background/building model). In some implementations, the one or more circuits can position the model (e.g., of an object or person-hereinafter “entity”) within the environmental model according to the configuration. In some implementations, the one or more circuits can update a position of the model in the scene according to a simulation of one or more physical constraints (e.g., of gravity). In some implementations, the model is a first model (e.g., of an entity), the scene is generated to include a second model (e.g., of another entity, or another instance of the first entity), and the one or more circuits can simulate a collision between the first model and the second model. In some implementations, the data selected for the model comprises at least one of a color, a pattern, a texture, or a material.

In some implementations, the one or more circuits can generate a label for the image based at least on the appearance of a representation of the model within the scene. In some implementations, the one or more circuits can determine a pose for the model according to the configuration. In some implementations, the one or more circuits can determine the pose by simulating an animation selected for the model according to the configuration. In some implementations, the one or more circuits can position the model within the scene relative to a viewpoint (e.g., camera orientation/position) used to generate the image.

In some implementations, the one or more circuits can generate a plurality of scenes according to the configuration. In some implementations, the one or more circuits can generate a plurality of images using the plurality of scenes. In some implementations, the one or more circuits can filter (e.g., compensate for darkness or models blocking the camera) the plurality of images based at least on an illumination of the plurality of scenes or a placement of models within the plurality of scenes.

At least one other aspect is related to a processor. The processor can include one or more circuits. The one or more circuits can generate a synthetic scene including a plurality of models positioned according to the configuration file. At least one model of the plurality of models can include a semantic layer having a property randomized according to a distribution specified in a configuration file. The one or more circuits can simulate movement of the at least one model within the synthetic scene. The one or more circuits can render the synthetic scene to generate an image for updating a neural network.

In some implementations, the one or more circuits can simulate movement of the at least one model by simulating a gravitational force within the synthetic scene. In some implementations, the one or more circuits can simulate movement of the at least one model by simulating a collision between the at least one model and a second model of the plurality of models within the synthetic scene. In some implementations, the one or more circuits can simulate movement of the at least one model by adjusting the at least one model according to an animation. In some implementations, the one or more circuits can select an animation frame of the animation according to the configuration file.

Yet another aspect of the present disclosure is related to a method. The method can include receiving, by using one or more processors, a configuration that specifies randomization for a semantic layer of a model for a scene. The method can include sampling, using the one or more processors, a distribution according to the randomization to select data for the semantic layer of the model. The method can include generating, using the one or more processors, the scene including the model having the data selected for the semantic layer. The method can include rendering, using the one or more processors, the scene including the model to generate an image for updating a neural network.

In some implementations, the method can include generating, using the one or more processors, the scene to include an environmental model. In some implementations, the method can include positioning, using the one or more processors, the model within the environmental model according to the configuration. In some implementations, the method can include updating, by using the one or more processors, a position of the model in the scene according to a physical simulation.

The processors, systems, and/or methods described herein can be implemented by or included in at least one of a system associated with an autonomous or semi-autonomous machine (e.g., an in-vehicle infotainment system); a system for performing simulation operations; a system for performing digital twin operations; a system for performing light transport simulation; a system for performing collaborative content creation for 3D assets; a system for performing deep learning operations; a system implemented using an edge device; a system implemented using a robot; a system for generating or presenting virtual reality (VR) content, augmented reality (AR) content, and/or mixed reality (MR) content; a system for performing conversational AI operations; a system for performing generative AI operations using a large language model (LLM), a system for generating synthetic data; a system incorporating one or more virtual machines (VMs); a system implemented at least partially in a data center; or a system implemented at least partially using cloud computing resources.

### BRIEF DESCRIPTION OF THE DRAWINGS

The present systems and methods for controllable trajectory generation using neural network models are described in detail below with reference to the attached drawing figures, wherein:

FIG. 1 is a block diagram of an example system that implements generation of realistic and diverse simulated scenes including people for updating/training artificial intelligence models, in accordance with some embodiments of the present disclosure;

FIG. 2 is a block diagram of an example process for generating a simulated scene according to input configuration data, in accordance with some embodiments of the present disclosure;

FIG. 3 depicts an example rendering of a simulated scene generated using the techniques described herein, in accordance with some embodiments of the present disclosure;

FIG. 4 depicts another example rendering of a simulated scene generated using the techniques described herein, in accordance with some embodiments of the present disclosure.

FIG. 5 is a flow diagram of an example of a method for generating realistic and diverse simulated scenes including people for updating/training artificial intelligence models, in accordance with some embodiments of the present disclosure;

FIG. 6 is a block diagram of an example content streaming system suitable for use in implementing some embodiments of the present disclosure;

FIG. 7 is a block diagram of an example computing device suitable for use in implementing some embodiments of the present disclosure; and

FIG. 8 is a block diagram of an example data center suitable for use in implementing some embodiments of the present disclosure.

### DETAILED DESCRIPTION

This disclosure relates to systems and methods that generate realistic and diverse simulated scenes including people for training/updating vision-based artificial intelligence models, such as neural networks. Training/updating approaches for artificial intelligence models include the use of labeled training images or videos, which are traditionally sourced from various public and private datasets, online repositories, or captured using cameras. However, externally-sourced training data can suffer from a plethora of potential issues. For example, the training data may violate privacy regulations or agreements, may be challenging to label accurately and consistently, may lack sufficient diversity or specificity, and may vary in terms of overall data consistency and/or quality.

One approach to overcoming these challenges is the use of curated, synthetically generated data. Techniques for synthetically generating training data in accordance with one or more embodiments of the present disclosure involve using a simulator to produce scenes that include known environments, objects, or other features. The simulated scenes may be rendered according to various viewing angles or conditions to produce images. Synthetic training data has improved customizability, can cover a far larger degree of environments and settings, and can be used to generate conditions that may be rare, unsafe, or infeasible to capture in the real world. Further, simulations can automatically provide exact labels that would otherwise be labor-intensive or impossible to achieve with real data.

Conventional approaches for generating synthetic datasets with people include the generation of simulated environments including people and objects floating in space, or people animated in front (e.g., the foreground) of two-dimensional (2D) images. However, these approaches fail to incorporate characteristics that may be present in the real world, and which may be useful in training/updating artificial intelligence models to accurately generalize to real-world images or video. Examples of such characteristics include properly simulated ground, walls, or interior environments, and physical phenomena such as gravity or collisions. Traditional simulated datasets further lack sufficient realism, particularly datasets that include images of simulated people. Artificial intelligence models updated/trained on simulated datasets lacking physical realism can exhibit poor or inconsistent performance when exposed to images of the real world, regardless of the size of the simulated training dataset.

To address these issues, the systems and methods described herein provide techniques for generating simulated training datasets including images that exhibit accurate physical realism, high randomization, and/or diversity for generalization to many conditions. Enhancing randomization and diversity of simulated datasets can be achieved in part by targeting randomization at different, specific regions or sub-elements of models placed within the simulation. In one example, the clothing of a model of a person may be randomized across a collection of clothing textures, colors, or materials, while skin or hair can be alternatively randomized across a different range of colors. Partial randomization of models, materials, and/or textures results in a greater degree of diversity even when using a limited set of three-dimensional (3D) assets, while still maintaining a degree of realism that is sufficient to generalize artificial intelligence models to real-world images.

The present techniques can provide approaches for improving the realism of simulated environments in which simulated entities (people or objects) are placed. Simulated backgrounds or 3D environments, such as warehouses, office spaces, building interiors, or outdoor terrain may be pre-generated or procedurally generated to provide realistic backgrounds for simulated training images or video. Entities can be randomized and/or placed within the 3D environment, with additional constraints and modifications to improve diversity and realism. For example, randomized animations may be selected for models of people that are placed within a scene, and physical constraints such as gravity and collision physics can be applied such that people and objects do not intersect. Simulated scenes may be automatically parameterized to reflect real-world compositions and may implement realistic lighting, building design, and/or object types.

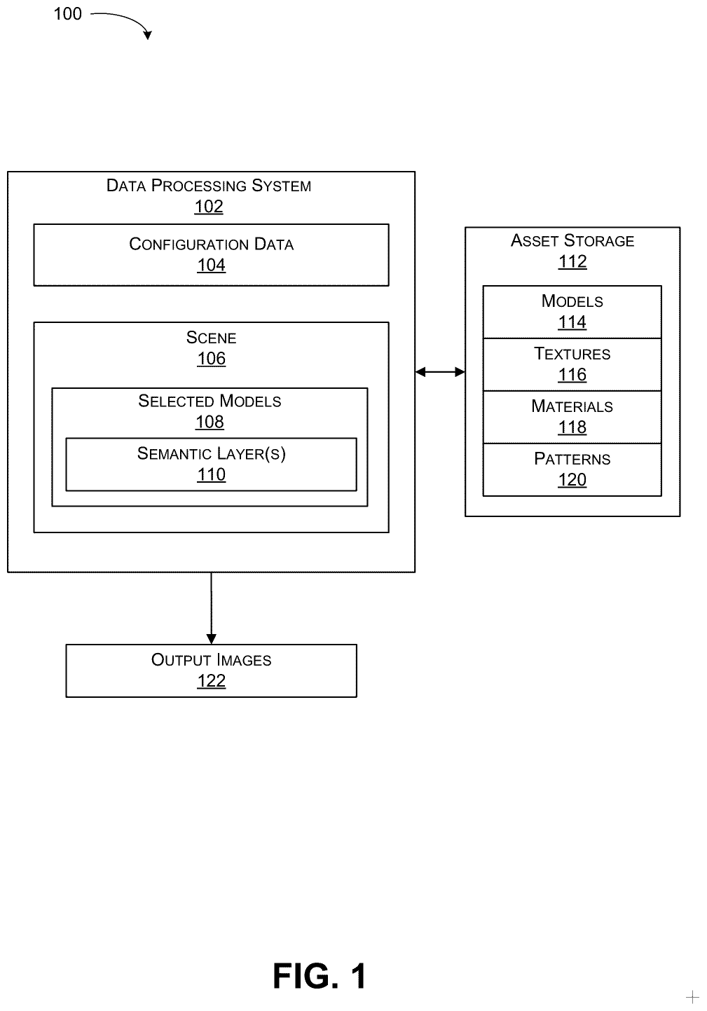

FIG. 1 is an example computing environment including a system 100, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. The system 100 can include any function, model (e.g., machine-learning model), operation, routine, logic, or instructions to perform functions such as generating and rendering scenes 106 as described herein, to generate the output images 122 that may be utilized to update/train artificial intelligence models.

The system 100 is shown as including the data processing system 102 and the asset storage 102. The data processing system 102 can access configuration data 104 to generate one or more scenes 106, which may be rendered to generate one or more output images 122. The data processing system 102 may generate a scene 106. The scene 106 can include a simulated, 3D environment including 3D models (e.g., the selected models 108) having randomized locations, attributes, and in some implementations, semantic layers 110. The simulated scene 106 can be rendered by the data processing system 102 to produce datasets including the output images 122. The scene 106 can be generated, for example, in response to a request from an external computing device (e.g., a client device) in communication with the data processing system 102 or in response to operator input at an input device of the data processing system 102. The request, or input, may include or specify the configuration data 104, which may be parsed by the data processing system 102 to enumerate parameters and/or distributions for generation of the scene 106.

The configuration data 104 can include one or more files, data structures, and/or objects stored or received by the data processing system 102. The configuration data 104 can specify various data relating to how the scenes 106 are to be rendered, including the placement of 3D models (e.g., the selected models 108) within simulated environments. The configuration data 104 may specify distributions or other random selection criteria, which may be utilized to randomize various parameters of the scene 106, including any semantic layers 110 of selected models 108 placed within the scene 106.

The configuration data 104 may include parameter data, which may include input parameters used by the data processing system 102 to generate and simulate a scene 106. The parameters may include, but are not limited to, entity parameters, lighting (illumination) parameters, scenario parameters, camera parameters, output parameters, or other parameters. Entity parameters may specify one or more 3D models for one or more entities, dimensions of one or more entities, locations of one or more entities within a scene 106, movement information for one or more entities (e.g., translational motion, rotational motion, animation information, etc.), as well as classification or label information for one or more entities. The 3D models within the scene (shown here as the selected entity models 108) can be any type of 3D model that visually represents a physical object or person. The configuration data 104 may specify a path or storage location from which one or more 3D entities should be selected for the scene 106 (e.g., selected models 108) and, in some implementations, may specify one or more specific 3D models to include within the scene 106.

Lighting parameters may specify the location, shape, color, brightness, and movement (e.g., translational motion, rotational motion, etc.) of one or more light sources (illuminants) within a scene. Scenario parameters can specify the parameters of an environment within the scene 106 within or upon which the entities will be placed. The scenario parameters may specify an environmental model (e.g., a model of a building interior, a sky box, etc.), room information (e.g., dimensions and appearance of a room, if any), as well as sky box parameters (e.g., size, texture, brightness, if any, etc.). The camera parameters may specify parameters for a camera positioned within the scene 106 for 3D rendering, to produce one or more output images 122. The camera parameters may specify a resolution and lens characteristics of the camera, a location (e.g., translational position, rotation, etc.) of the camera within the scene 106, as well as movement information for the camera, which may specify movement sequences or paths upon which the camera travels to render different locations within the scene 106.

The configuration information 104 may specify one or more output parameters for the output images 122, including the number or name of the output images 122 (e.g., an output dataset), sequence information for the output images 122 (e.g., parameters for configuring how many timesteps the scene 106 is simulated), as well as output formats for each output image 122, which may include formats such as red-green-blue (RGB) images, as well as corresponding images showing segmentations of different objects and/or the environment model, bounding boxes (e.g., 2D or 3D bounding boxes), depth maps, and/or occlusion data, among others. The configuration data 104 may specify a storage location from which assets used to generate the scene 106 are to be retrieved, as well as a storage location at which the output images 122 (and any additional corresponding images) are to be stored.

The configuration data 104 may include one or more lists of assets, which may specify a storage location from which to select assets, as well as specific assets (or candidate assets for selection) for inclusion in the scene 106. The asset list may specify one or more of models 114, textures 116, materials 118, or patterns 120 that may be selected and utilized when generating a scene 106. The configuration data 104 may specify how different textures, materials 118, and/or patterns 120 are to be applied to the models (e.g., the selected models 108) placed within the scene. In some implementations, and as described in further detail herein, the configuration data 104 may specify how different textures 116, materials 118, and/or patterns 120 are to be applied to the semantic layers 110, if any, of one or more selected models 108 placed within the scene 106.

The models 114, textures 116, materials 118, and patterns 120 may be stored locally at the data processing system 102 or within an external storage system (shown here as the asset storage 112). The asset storage 112 may be an external server, distributed storage/computing environment (e.g., a cloud storage system), or any other type of storage device or system that is in communication with the data processing system 102. When generating the scene 106, the data processing system 102 can retrieve one or more models 114 to place within the scene, which are represented here as the selected models 108. The models 114 may include 3D mesh assets, which may represent any type of object. In some implementations, a model 114 may represent a person and may be associated with a label or classification identifying the model 114 as a person.

Models 114 may include semantic layers 110, to which semantic data can be applied to change the visual characteristics of the model 114. Semantic layers 110 may be/include individual portions of each model (e.g., a predetermined set of polygons, vertices, etc.) to which any type of semantic data (e.g., randomly selected textures 116, materials 118, or patterns 120) may be applied. Semantic layers 110 can enable a model 114 to include multiple portions that have different appearances when placed within a scene, rather than having a texture 116, material 118, and/or pattern 120 applied uniformly across the entire surface of the model. The semantic layers 110 of different models may be randomized independently according to the configuration data 104, and therefore enable a greater degree of diversity and control even when a relatively smaller set of models 114 are selected (e.g., as the selected models 108) for a scene 106.

The textures 116 include digital image files (e.g., PNG, JPEG, HDR, EXR, etc.) that are used to add detail and realism to the 3D models 114. Textures 116 can include 2D images that are mapped to the surface of a model 114. The materials 118 for a model 114 can be used to define the appearance of the model, such as its color, shininess, and transparency. The materials 118 can be used to create a variety of different effects, such as making a model 114 appear like metal, plastic, or wood. The materials 118 may include one or more one or more MDL files, and may define various properties, including shininess, transparency, and/or color. In some implementations, the materials 118 may include physical materials and/or procedurally generated materials. The materials 118 may be represented as textures with additional properties, like normal maps, specularity (reflectance), transparency, or specular colors, among others. The patterns 120 may be predetermined texture file patterns, or may include instructions to define (e.g., draw) one or more predetermined or randomly generated patterns on a surface of a 3D model (or a semantic layer 110 thereof). The patterns 120 may include image files.

Selected models 108 for a scene 106 may include multiple semantic layers 110. In an example where a selected model 108 is a 3D model of a person, one semantic layer 110 may represent the visual properties of an article of clothing worn by the person defined by the 3D model, another semantic layer 110 may represent the skin color of the 3D model, and another semantic layer 110 may represent a hair color of the 3D model. For example, based at least on the randomized parameters specified in the configuration data 104, the data processing system 102 may select one or more textures 116, materials 118, and/or patterns 120 to apply to each semantic layer 110. Furthering the example of a selected model 108 including a 3D model of a person, multiple semantic layers 110 of the 3D model may be randomized according to the configuration data 104 to select different skin colors, clothing textures/materials/patterns, and/or hair colors.

The same selected model 108 may be replicated and included in the same scene 106 multiple times, but with different data applied to the semantic layers 110 of each model, causing representations of each selected model 108 to appear different from each other. This can increase the diversity of the output images 122 without requiring a diverse set of models 114 from which to construct the scene 106. Similar techniques may be applied to a model 114 that defines an environment (e.g., an exterior environment, a skybox, a building interior model, etc.) for the scene 106, allowing a single model 114 of the environment to vary in appearance across multiple scenes 106.

In an example process for generating a scene 106, the data processing system 102 can access the configuration data 104 for the scene to identify parameters for the selection of models 114, textures 116, materials 118, and/or patterns 120 for the scene. Any parameter described herein relating to the generation of the scene 106 can be parsed from the configuration data 104, including placement and/or physical simulation data for models 114 for the scene 106 or environmental models 114 for the scene 106. Models 114 selected for the scene can be retrieved and stored or otherwise accessed as the selected models 108. Semantic layers 110 for each selected model 108 may be randomized by selecting various textures 116, materials 118, and/or patterns 120 to apply to the semantic layer 110 of the selected model 108 when constructing the scene. The semantic layers 110 may be defined as part of the file storing the selected model 108, and may be randomized according to the parameters specified in the configuration data 104.

The data processing system 102 may place additional elements into the scene 106, such as lights, simulated fluids, two-dimensional (2D) sprites, and/or various visual effects. Once the selected models 108, lights, and other visual effects have been placed in the scene 106, the data processing system 102 may place and/or navigate a virtual camera or other rendering viewport within the scene 106 to generate the output images 122. The data processing system 102 may render the scene 106 by simulating the way that light travels from objects in the scene to the camera or viewport. Parameters of the camera may include position and orientation in the scene 106, field of view, and focal length, among others. The configuration data 104 may specify the parameters for the camera, the number of output images 122 to be generated from the scene, and may define a path (e.g., a series of positions and/or orientations) within the scene 106 at which the camera is to be positioned to generate corresponding output images 122.

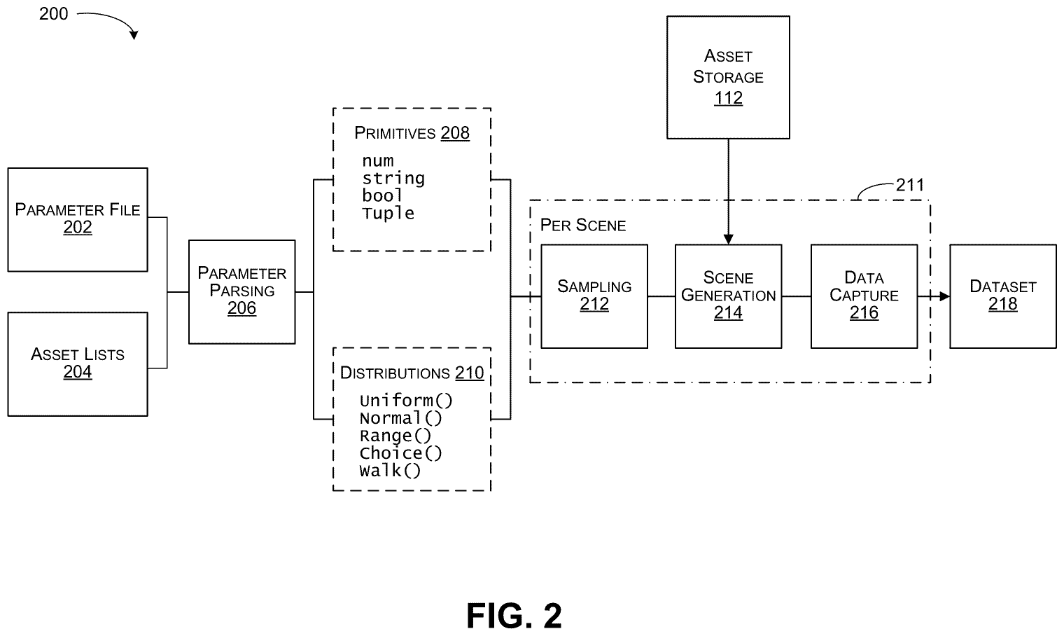

The output images 122, once captured by rendering the scene 106 via the viewport, may be stored in association with various labels, segmentations, bounding boxes, or other relevant data generated by the data processing system 102. This additional information may be stored in association with each output image 122 and may be utilized as ground-truth data when updating/training vision-based artificial intelligence models such as deep convolutional neural networks. The format and types of labels, segmentations, and/or bounding boxes generated in association with each of the output images 122 may be specified as part of the configuration data 104. Further details of an example process that may be implemented by the data processing system 102 to generate output images 122 is described in connection with FIG. 2.

Referring to FIG. 2, depicted is a block diagram of an example process 200 for generating a simulated scene (e.g., the scene 106) according to input configuration data (e.g., the configuration data 104), in accordance with some embodiments of the present disclosure. As shown, the process 200 begins by performing a parameter parsing process 206 using a parameter file 202 and asset list(s) 204. The parameter file 202 and the asset lists 204 may collectively be/include configuration data and may define various parameters for generating one or more scenes and output images resulting from rendering said scenes. The parameter parsing process 206 may implement any suitable text parsing, binary processing, and/or decompression algorithms to extract one or more primitives 208 and distributions 210 defined via the parameter file 202.

As described in connection with FIG. 1, configuration data for generating a scene may include multiple parameters for the scene, which in this example process 200 may be specified via the parameter file 202. The parameter file 202 may have any suitable format, including a YAML file, a JSON file, an INI file, or any other type of file that may be utilized to specify one or more parameters for the scene. The parameter file 202 may be specified via a remote request (e.g., via a uniform resource identifier (URI) parameter), via command-line input, or via another configuration file accessed by the computing system executing the process 200.

The parameters defined by the parameter file 202 may include but are not limited to object parameters, light parameters, scenario parameters, camera parameters, output parameters, or other parameters. Object parameters may specify one or more 3D models for one or more objects, dimensions of one or more objects, locations of one or more objects within a scene 106, movement information for one or more objects (e.g., translational motion, rotational motion, animation information, etc.). The 3D models within the scene can be any type of model that represents a physical object or person within the scene. Lighting parameters may specify the location, shape, color, brightness, and movement (e.g., translational motion, rotational motion, etc.) of one or more lights within a scene. Scenario parameters can specify the parameters of an environment within the scene 106 within or upon which the objects will be placed. The camera parameters may specify a resolution and lens characteristics of the camera, location information of the camera, movement information for the camera.

Certain parameters specified in the parameter file 202 may be specified via primitive values 208, which in some implementations may be non-randomized datatypes such as numeric datatypes (e.g., the “num” datatype in YAML, etc.), string-based datatypes (e.g., the “string” datatype in YAML, etc.), Boolean datatypes (e.g., the “bool” datatype in YAML, etc.), and other data structure datatypes such as tuples (e.g., the “tuple” datatype in YAML, etc.), vectors, arrays, matrices, or lists, among others. The primitive values 208 may be utilized to specify certain parameters that remain static during the simulation of the scene, and may be explicitly specified or evaluated by the computing system performing the process 200 when the parameter file 202 is accessed.

Some parameters specified in the parameter file 202 may be specified via distributions 208, which may be utilized to automatically generate one or more random values for an associated parameter. The distributions 208 may include, but are not limited to, uniform distributions (which may return a floating point value between specified minimum and maximum values), normal distributions (based at least on a specified mean and standard deviation), a range distribution (which may return an integer value between specified minimum and maximum integer values), choice distributions (which may return an element from a list of elements, such as a list of assets in one or more asset lists 204), or a walk distribution (which may be a choice distribution without replacement).

In some implementations, distributions, including the choice distribution or the walk distribution, may be specified in the parameter file 202 to randomly select certain assets for placement in the scene. For example, the parameter file 202 may include a choice distribution that specifies random selection of a texture from a list of textures in an asset file 202 to apply to a sematic layer of a 3D model that is randomly selected for placement for the scene. Other types of distributions, such as uniform distributions and normal distributions, may be utilized to randomly generate numerical values, such as values that specify the placement coordinates and/or rotation of a 3D model within a scene. For example, rather than explicitly specifying a location of a 3D model within a scene, the parameter file 202 may specify that the position of the model is to be generated using a uniform distribution between specified minimum and maximum coordinate boundaries. Furthering this example, these boundaries may be selected based at least on an environmental 3D model for the scene, such that the 3D model is to be randomly placed within the 3D environment model.

The parameter file 202 may specify how different objects (e.g., 3D models), lights, skyboxes, background textures, and/or 3D environmental models are to be arranged within the simulated scene, along with various parameters thereof. The parameter file 202 may specify parameters for semantic layers (e.g., semantic layers 110) of 3D models that are to be selected for the scene. The semantic layers may be portions of 3D models to which textures, materials, patterns, and/or colors may be applied, such that a 3D model may be represented using multiple textures, materials, patterns, and/or colors. In an example where a 3D model is a model of a person, one semantic layer may correspond to clothing of the 3D model, another semantic layer may correspond to skin color of the 3D model, and yet another semantic layer may correspond to hair color of the 3D model. Semantic layers are not limited to 3D models representing people and may be included and modified for any suitable model described herein.

The parameter parsing process 206 may further extract various simulation parameters for the simulated scene, including whether certain 3D models are to be affected by gravity, collisions, or other simulated physical forces, as well as whether certain 3D models are to be animated. In some implementations, the parameter parsing process 206 may parse the parameter file to extract parameters (including distributions) that specify particular animation frames at which an animation for a 3D model is to be started. The starting animation frame may be randomized so as to increase diversity in the output dataset.

In some implementations, the parameter file 202 may include references to other parameter files, data from which may be inherited or otherwise included in the parameter file 202 during the parameter parsing process 206. Parsing the parameter file can include identifying each parameter that is utilized to specify an attribute of the scene as well as any cameras, lights, or objects (e.g., 3D models) placed therein. For example, the parameter file 202 may be a YAML file that specifies key-value pairs, where each key identifies a parameter, and the value specifies the value of that parameter (which may be a primitive value 208 or a distribution 210). The configuration data 104 may specify a path or storage location from which one or more 3D objects should be selected for the scene 106 (e.g., selected models 108) and, in some implementations, may specify one or more specific 3D models to include within the scene 106.

Once the parameters have been parsed from the parameter file 202, and corresponding paths to assets have been parsed from the asset lists 204, one or more scenes can be simulated in the simulation process 211. The simulation process 211 includes, for each simulated scene that is to be generated, a sampling process 212, a scene generation process 214, and a data capture process 216. The simulation process 211 may be executed for each scene that is to be generated (which may be specified via the parameter file 202) to generate corresponding output datasets 218 (e.g., including output images 122) for each scene.

The sampling process 212 can be executed to generate values or to select assets according to the distribution parameters 210 parsed from the parameter file 210. For example, the sampling process may select one or more random values from specified uniform distributions or normal distributions, or may select assets from one or more lists of assets (e.g., in specified asset file(s) 204) according to the choice distributions or walk distributions specified in the parameter file. Doing so may include executing one or more random number generation algorithms, including random number generation algorithms that sample from Gaussian distributions or uniform distributions. Identifiers of the selected assets (e.g., models, textures, patterns, colors, etc.), as well as any other parameters generated by sampling the distributions 210, may be provided as input to the scene generation process 214, along with any primitive (e.g., constant) parameters parsed from the parameter file 202.

The scene generation process 214 can access the asset storage 111 (described in connection with FIG. 1) to retrieve the assets selected from the sampling process and any assets specified as primitive parameters 208 in the parameter file 202. For example, assets selected from the asset lists 204 via the sampling process 212 may be retrieved using corresponding path strings specified associated with the selected assets. In some implementations, the scene may be housed or contained within an environment model or a procedurally generated environment (e.g., a texture box environment with one or more randomized textures, materials, patterns, and/or colors). The scene generation process 214 may then simulate a 3D environment including the retrieved assets by placing the assets within a three-dimensional space. Assets may include 3D models (e.g., objects), environment models or 2D background textures, lights, and camera(s) or view port(s).

The placement (e.g., location, rotation, etc.) of objects or other assets within the scene may be determined based at least on the parameters extracted via the sampling process 212 or specified directly in the parameter file 202 using corresponding primitive parameters 208. Objects or lights may be placed within the scene based at least on absolute coordinates or relative coordinates (e.g., relative to a camera or another point or object within the scene, etc.). Combinations of dropped and flying objects may be incorporated into the scene to increase dataset complexity while maintaining realistic object positions.

As described herein, 3D models may include semantic layers (e.g., semantic layers 110), which may be randomized by applying selected textures, patterns, and/or materials to the semantic layers of the 3D models. In one example, the 3D models may include 3D models of people, and the semantic layers may correspond to one or more of articles of clothing, skin color, hair color, eye color, or other visual aspects of the 3D models. Semantic layers may include predetermined sets of polygons, vertices, or portions of a 3D model to which different textures, patterns, colors, and/or materials may be applied relative to other polygons, vertices, or portions of the 3D model. The 3D models described herein may include multiple semantic layers may each be randomized differently, enabling a greater degree of diversity even when using a limited pool of assets.

Asset files 204 may specify/identify assets to apply to the 3D models of people, such that sufficient realism is achieved when rendering the scene. Selection of the environment model, as well as the placement of entities and lights within the scene, may be parameterized to reflect real world compositions, thereby improving overall realism of the simulated scene. Prior to or following entity placement, the scene generation process 214 may include populating the semantic layers of the 3D models with the textures, patterns, colors, and/or materials selected via the sampling process 212 (or that were explicitly specified as a primitive parameter 208 in the parameter file 202). Applying the textures, patterns, materials, and/or colors may include populating predetermined regions of memory corresponding to the semantic layers with data selected from the asset lists 204. In one example, to improve updating/training of artificial intelligence models, challenging synthetic patterns may be sampled one or more the semantic layers, such as checkboard patterns or swirling colors.

The scene generation process 214 may also include performing a physical simulation of one or more 3D models positioned within the scene. As described herein, parameters parsed from the parameter file 202 may specify which, if any, 3D models that are to be placed within the scene are to be physically simulated. The physical simulation may include the simulation of physical forces applied to the corresponding 3D models, including simulated gravity or other external forces. Collisions may be simulated between the one or more 3D models, including for example, between one or more models of entities (e.g., animate or inanimate objects, or people, animals, or other actors) and an environmental model. Simulating collisions between objects in the scene prevents objects from intersecting upon rendering, improving realism of the scene.

The scene generation process 214 may include arranging one or more 3D models placed within the scene according to animations specified via the parameter file 202. The animations may be applied to 3D models of entities in the scene through rigging, which includes posing a skeleton or wire rig of the 3D model according to one or more keyframes. Keyframes include points in time at which the joints and segments of the skeleton/rig applied to the model are in a specific pose. When a skeleton/rig is applied to a 3D model, the vertices of the 3D model are assigned to corresponding segments of the skeleton/rig, causing the 3D model to pose according to the positions and orientations of the segments specified in the keyframe. Example animations of people may include standing, sitting, walking, running, or typing on a keyboard, among others.

The scene generation process 214 may include posing one or more 3D models according to a selected keyframe of an animation, each of which may be specified in the parameter file 202. The specific keyframe of each animation may be randomized as a distribution parameter 210. In some implementations, different animations may be selected for duplicates of the same 3D model within the scene. Simulating the scene may include advancing the keyframes and physical simulations of the objects in the scene by a predetermined number of timesteps, or by a number of timesteps determined from the parameter file 202. For example, the parameter file 202 may specify that, prior to initiating the data capture process, one or more animations and/or physical simulations are to be advanced by a predetermined number of timesteps. Once the scene has been generated (and in some implementations, simulated), the data capture process 216 be initiated to generate one or more output images (e.g., the output images 122) for storage as part of an output dataset 218.

The data capture process 216 may include rendering the generated scene, which for example includes lights, objects (e.g., 3D models, including 3D models of people having semantic layers), and/or background to generate output images for the dataset 218. The output images may be stored in any suitable format, including PNG, JPEG, HDR, or EXR files, among others. Any suitable rendering process may be utilized to render the scene via one or more cameras or viewports placed within the scene, including but not limited to rasterization or light transport simulation techniques such as ray tracing. The types of output data generated from the scene may be specified in the parameter file 202.

The parameter file 202 may further specify that the scene is to be simulated for additional timesteps between rendering one or more output images. This can enable the scene to be physically simulated over time, for entities to move or animate across multiple frames, or to enable the scene to be rendered from different angles by moving the camera(s) along predetermined (or randomly generated) paths. During the data capture process 216 (e.g., between rendering frames of the scene), the scene may be simulated by advancing animations by predetermined numbers of frames, or by physically simulating entities within the scene according to predetermined (or randomly generated) numbers of time steps.

In some implementations, the data capture process 216 may include filtering one or more output images and/or the scene itself if the output images and/or scene is not suitable for image generation. For example, if the scene is too dark due to how lights were randomly positioned within an environment model, or if one or more randomly placed objects occlude the camera and therefore obscure visualization of objects in the scene, the scene itself or the particular output image may be discarded. In some implementations, a predetermined number of output images may be generated as part of the data capture process 216. The parameter file 202 may specify one or more types of output data generated via the data capture process. For example, additional images such as segmentation images, bounding boxes, and/or depth images may be generated, which may be utilized in connection with artificial intelligence training processes. The additional images and/or output data may be generated based at least on classification labels associated with each asset.

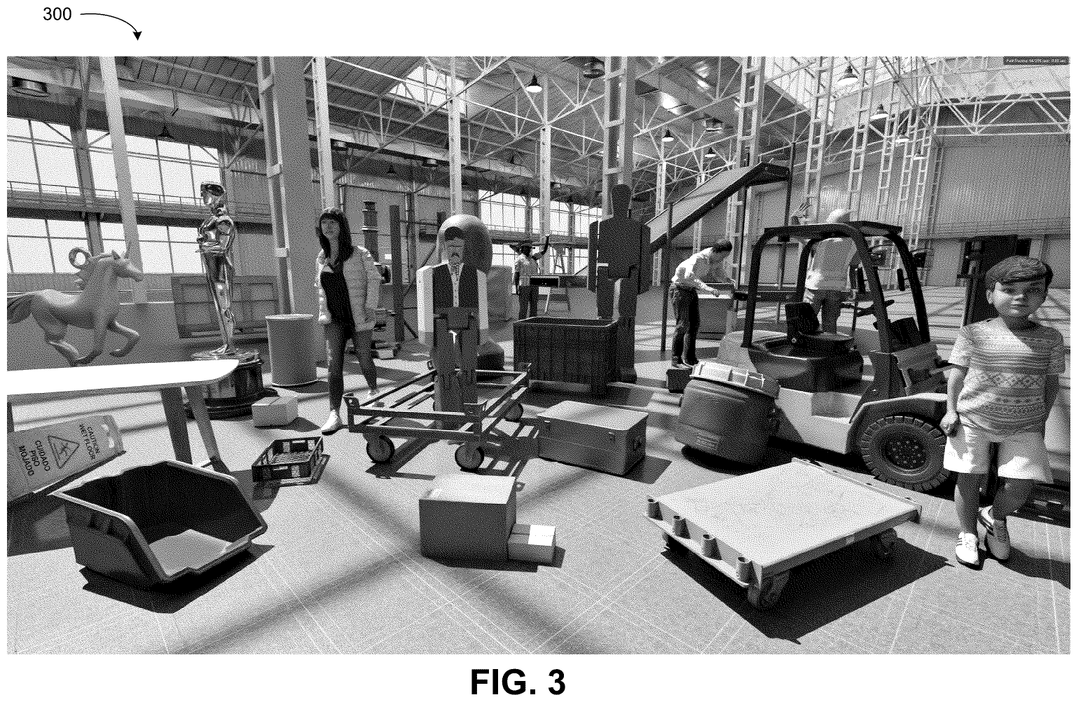

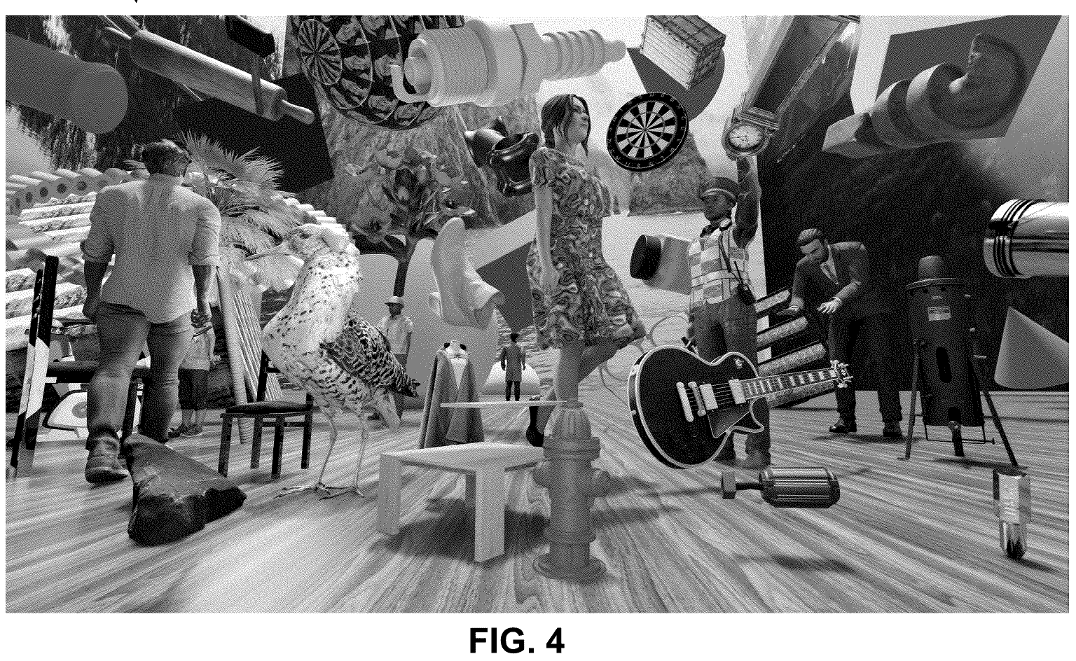

The simulation process 211 may be repeated for each scene that is to be generated (e.g., specified in the parameter file 202). The parameter file 202 may further specify a number of output images to generate for each scene, and how the output images are to be stored as part of one or more output datasets 218. In some implementations, an output dataset 218 may include a collection of output images generated from a single scene. In some implementations, an output dataset may include a collection of output images generated from multiple scenes. The simulation techniques described herein can be utilized to generate a variety of different scenes and output images for an output dataset 218. The datasets 218 may include output images stored in association with corresponding ground-truth data, including any classification labels, segmentation images, depth images, bounding boxes (e.g., tight bounding boxes, loose bounding boxes, etc.), among others. The datasets 218 may be utilized in training tasks for any type of vision-based artificial intelligence model. Example output images generated using the techniques described herein are shown in FIGS. 3 and 4.

Referring to FIG. 3, depicted Is an example rendering 300 of a simulated scene generated using the techniques described herein. In this example, the environment model selected for the scene is a warehouse interior, with several objects positioned therein that may be traditionally found within a warehouse, such as bins, industrial equipment, and signage. Additionally, 3D models of people in different poses are shown. False positive models of people, which are objects that appear as people but are instead other/alternative objects such as dolls or statues, may sometimes be selected for inclusion in one or more scenes to improve classification accuracy of vision-based artificial intelligence models. As shown, some of the objects positioned within the scene have been subjected to simulated gravity and collisions, such that the objects are positioned on the floor of the warehouse model and do not intersect with one another.

Referring to FIG. 4, illustrated is another example rendering 400 of a simulated scene generated using the techniques described herein. The example rendering 400 of FIG. 4 is a more abstract rendering compared to FIG. 3. Rather than a realistic warehouse model, the background of the scene is a randomly selected two-dimensional texture. In addition, combinations of flying objects and objects subjected to gravity are depicted. Models of people are also included in the rendering 400, with the model of the woman near the center of the image having a semantic layer representing a dress that has an abstract swirl pattern. As described herein, such patterns are challenging for certain vision-based artificial intelligence models to properly classify, and therefore can serve as useful training data. For example, saturated or high-contrast patterns, such as swirls, checkerboards, or stripes, enhance the robustness of the model by preventing overfitting to synthetically generated training data. Additional abstract objects are shown in the rendering 400 at various positions and orientations, including a bird, a spark plug, geometric shapes, and a fire hydrant, among others.

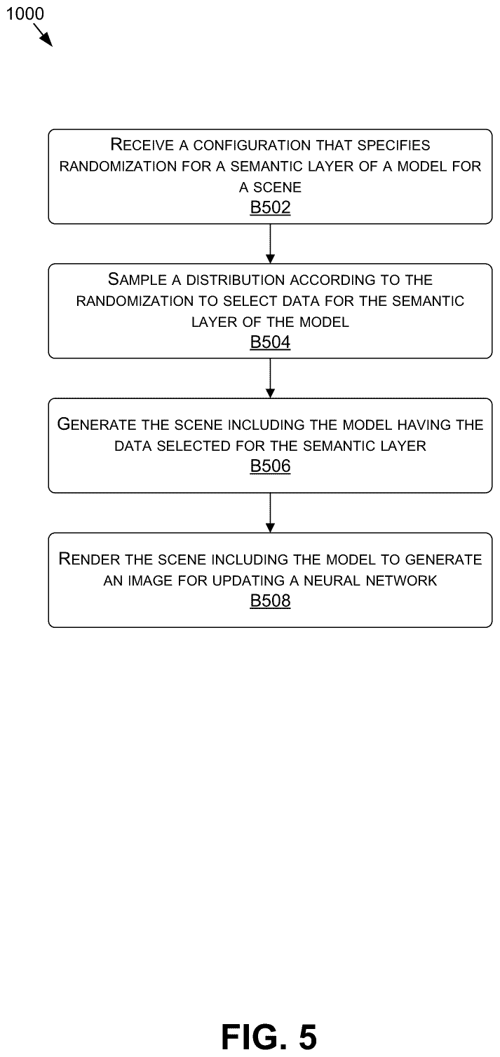

Referring to FIG. 5, illustrated is a flow diagram of an example of a method 500 for generating realistic and diverse simulated scenes including people for updating/training artificial intelligence models. Each block of method 500, described herein, comprises a computing process that may be performed using any combination of hardware, firmware, and/or software. For instance, various functions may be carried out by a processor executing instructions stored in memory. The method 500 may also be embodied as computer-usable instructions stored on computer storage media. The method 500 may be provided by a standalone application, a service or hosted service (standalone or in combination with another hosted service), or a plug-in to another product, to name a few. In addition, method 500 is described, by way of example, with respect to the system of FIG. 1, and may be utilized to implement any of the operations described in connection with FIGS. 1 and 2 to generate simulated scenes and corresponding output datasets. However, this method 500 may additionally or alternatively be executed by any one system, or any combination of systems, including, but not limited to, those described herein.

The method 500, at block B502, includes receiving a configuration (e.g., configuration data 104, parameter file(s) 202, asset list(s) 204, etc., via an interface/receiver) that specifies randomization for a semantic layer (e.g., a semantic layer 110) of a model (e.g., a model 114, a selected model 108, etc.) for a scene (e.g., a scene 106, etc.). The configuration may be received via a command line parameter, via a web-based request, or may be indicated in another configuration file started via the computing system executing the method 500. The configuration may specify primitive parameters (e.g., the primitive parameters 208) and/or distribution parameters (e.g., the distribution parameters 210). The configuration may specify what 3D models (e.g., the models 114) are to be selected for the scene (e.g., the selected models 108). The configuration may specify how the models are to be placed (e.g., location and/or orientation) and what textures, materials, patterns, and/or colors are to be applied to the models. In some implementations, the configuration can specify distribution parameters to select materials, patterns, textures, and/or colors for semantic layers of one or mor more models, as described herein.

The method 500, at block B504, includes sampling a distribution according to the randomization to select data for the semantic layer of the model. The distribution may be a normal distribution (e.g., a Gaussian distribution), a uniform distribution (e.g., a continuous range between specified minimum and maximum values), a range distribution (e.g., a discrete integer range between minimum and maximum values), or any other type of distribution that may be utilized to select random values. As described herein, the distributions may be utilized to specify parameters for models, including the random selection of materials, textures, patterns, and/or colors for semantic layers of 3D models placed within the scene. For example, an asset list may include a list of potential assets that may be selected for a semantic layer. An asset can be selected (e.g., a random choice with or without replacement) from the list based at least on a random value generated using a corresponding random number generation algorithm. The random number generation algorithm may be generated according to a specified or default distribution.

The method 500, at block B506, includes generating the scene including the model having the data selected for the semantic layer. Generating the scene may include populating/implementing/producing the 3D scene with environment models 3D models of objects and/or people, or other types of assets. In some implementations, 3D models can be positioned within the environmental model based at least on the distribution parameters or primitive parameters specified in the configuration, as described herein. The positions of the 3D models may be determined based at least on absolute coordinates or based at least on coordinates relative to another object or entity in the scene (e.g., a camera viewpoint, etc.).

The positions of the models may be updated based at least on physical simulations of the models, which may apply forces such as gravity to cause the models to be arranged in the scene in a realistic manner. Collisions between models may be simulated such that the models do not intersect with one another. Collisions may be simulated between any number of 3D models placed within the scene, including the environmental model. Simulating the scene may further include posing one or more models according to selected animations. For example, certain models may be associated with skeletons that enable the model, such as a model of a person, to be arranged in different poses. In some implementations, keyframes for animations that define different poses for models may be randomly selected based at least on the configuration, as described herein. The animation may be simulated, for example, by posing one or more models within the scene according to the positions of the model's skeleton defined in one or more keyframes of the animation. The animation may be simulated for multiple timesteps by re-posing the model according to the positions defined in a series of keyframes that define the animation.

The method 500, at block B508, includes rendering the scene including the model to generate an image for updating a neural network. Rendering the scene may include performing a process for generating output images (e.g., the output images 122) for a training dataset (e.g., the dataset 218). The output images may be rendered, for example, using a rasterization process, a ray tracing process, or another suitable rendering process. Rendering may be performed by placing a camera entity within the scene having a viewport that captures a portion of the scene (e.g., according to lens attributes, field of view, etc., as defined in the configuration). The rendering process may be performed to generate multiple output images from the scene, for example, over a predetermined (or randomly determined) number of simulated timesteps, or at different camera positions and/or orientations within the scene. Additional outputs may also be generated based at least on stored classifications of objects placed within the scene, as described herein, including segmentation images, classification labels, and/or bounding boxes. The labels, segmentations, and/or bounding boxes may be generated for each object that appears within an output image, and may be utilized during a training process for a vision-based artificial intelligence model.

In some implementations, the method 500 may be utilized to generate any number of scenes and any number of output images for each scene. As described herein, the images and/or scenes may be filtered according to illumination criteria and/or occlusion criteria. For example, if the illumination of the scene does not satisfy a predetermined threshold (e.g., due to random placement of lights) such that the objects in the scene are not properly visible, the corresponding output image and/or scene may be discarded, and the method 500 may be re-executed to generate an alternative scene and corresponding output images. In another example, if one or more objects within the scene occlude the viewport of a camera used for rendering, the output images and/or scene may similarly be discarded. In yet another example, a scene may be rejected if any color, or group of similar colors (e.g., a color bin), is overrepresented relative to other colors in a view captured by the camera positioned in the scene. This avoids creating dataset images from scenes that may be ambiguous or lack any defining features. In some implementations, the camera and/or occluding object may automatically be moved (or in some implementations removed, in the case of an occluding object) such that the scene can be properly rendered.

In some implementations, the method 500 may include updating/configuring/training one or more artificial intelligence models using the generated output images and corresponding labels, segmentations, and/or bounding boxes. For example, vision-based neural networks such as deep convolutional neural networks may be updated/trained using a suitable training process, such as supervised learning, semi-supervised learning, or self-supervised learning using the output images generated via the method 500. Generated output images may be stored in corresponding output training datasets, which may be provided as input to the artificial intelligence models during the training process.

### Example Content Streaming System

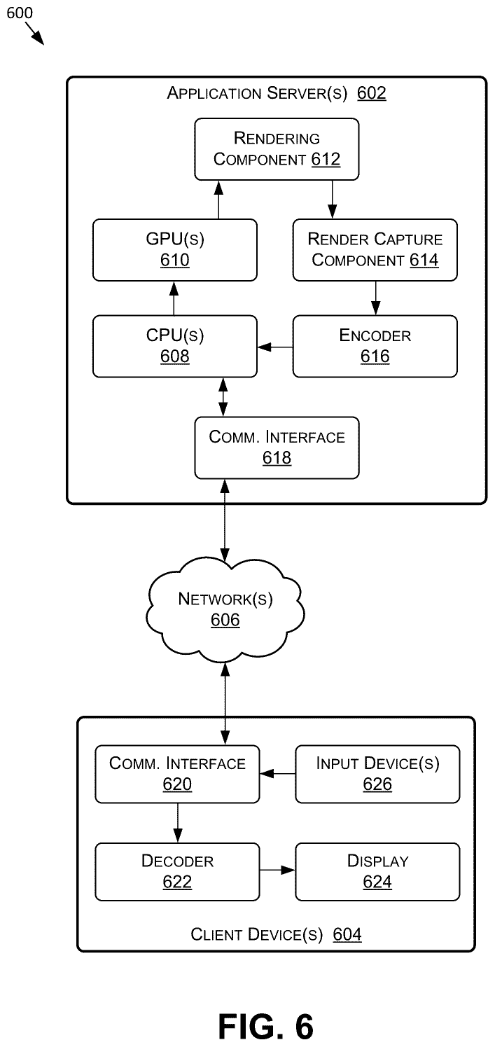

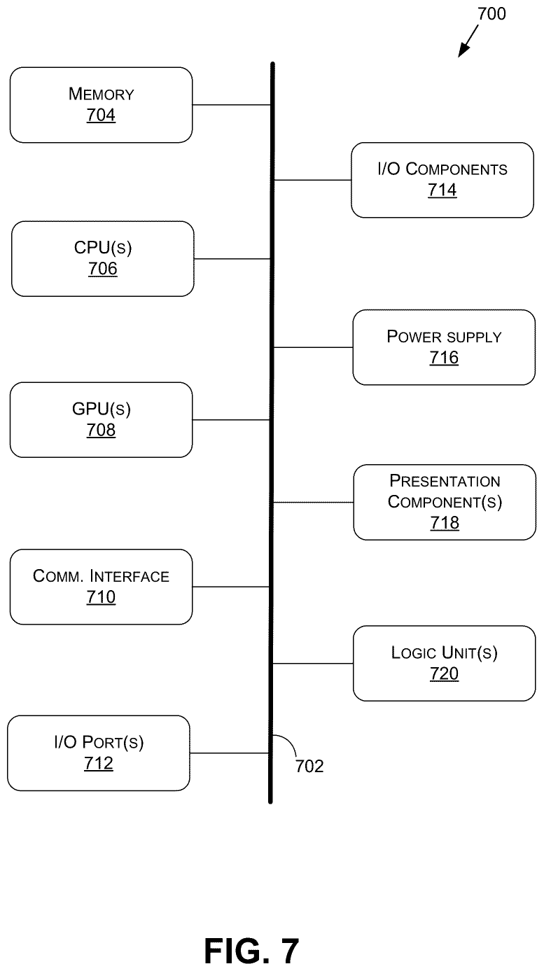

Now referring to FIG. 6, is an example system diagram for a content streaming system 600, in accordance with some embodiments of the present disclosure. FIG. 6 includes application server(s) 602 (which may include similar components, features, and/or functionality to the example computing device 700 of FIG. 7), client device(s) 604 (which may include similar components, features, and/or functionality to the example computing device 700 of FIG. 7), and network(s) 606 (which may be similar to the network(s) described herein). In some embodiments of the present disclosure, the system 600 may be implemented to simulate and render the various scenes described herein. The application session may correspond to a game streaming application (e.g., NVIDIA GEFORCE NOW), a remote desktop application, a simulation application (e.g., autonomous or semi-autonomous vehicle simulation), computer aided design (CAD) applications, virtual reality (VR) and/or augmented reality (AR) streaming applications, deep learning applications, and/or other application types. For example, the system 600 can be implemented to receive input indicating one or more features of output to be generated using a neural network model, provide the input to the model to cause the model to generate the output, and use the output for various operations including display or simulation operations.

In the system 600, for an application session, the client device(s) 604 may only receive input data in response to inputs to the input device(s) 626, transmit the input data to the application server(s) 602, receive encoded display data from the application server(s) 602, and display the display data on the display 624. As such, the more computationally intense computing and processing is offloaded to the application server(s) 602 (e.g., rendering—in particular ray or path tracing—for graphical output of the application session is executed by the GPU(s) of the application server(s) 602). In other words, the application session is streamed to the client device(s) 604 from the application server(s) 602, thereby reducing the requirements of the client device(s) 604 for graphics processing and rendering.

For example, with respect to an instantiation of an application session, a client device 604 may be displaying a frame of the application session on the display 624 based at least on receiving the display data from the application server(s) 602. The client device 604 may receive an input to one of the input device(s) 626 and generate input data in response. The client device 604 may transmit the input data to the application server(s) 602 via the communication interface 620 and over the network(s) 606 (e.g., the Internet), and the application server(s) 602 may receive the input data via the communication interface 618. The CPU(s) 608 may receive the input data, process the input data, and transmit data to the GPU(s) 610 that causes the GPU(s) 610 to generate a rendering of the application session. For example, the input data may be representative of a movement of a character of the user in a game session of a game application, firing a weapon, reloading, passing a ball, turning on a vehicle, etc. The rendering component 612 may render the application session (e.g., representative of the result of the input data) and the render capture component 614 may capture the rendering of the application session as display data (e.g., as image data capturing the rendered frame of the application session). The rendering of the application session may include ray or path-traced lighting and/or shadow effects, computed using one or more parallel processing units—such as GPUs, which may further employ the use of one or more dedicated hardware accelerators or processing cores to perform ray or path-tracing techniques—of the application server(s) 602. In some embodiments, one or more virtual machines (VMs)—e.g., including one or more virtual components, such as vGPUs, vCPUs, etc.—may be used by the application server(s) 602 to support the application sessions. The encoder 616 may then encode the display data to generate encoded display data and the encoded display data may be transmitted to the client device 604 over the network(s) 606 via the communication interface 618. The client device 604 may receive the encoded display data via the communication interface 620 and the decoder 622 may decode the encoded display data to generate the display data. The client device 604 may then display the display data via the display 624.

### Example Computing Device

FIG. 7 is a block diagram of an example computing device(s) 700 suitable for use in implementing some embodiments of the present disclosure. Computing device 700 may include an interconnect system 702 that directly or indirectly couples the following devices: memory 704, one or more central processing units (CPUs) 706, one or more graphics processing units (GPUs) 708, a communication interface 710, input/output (I/O) ports 712, input/output components 714, a power supply 716, one or more presentation components 718 (e.g., display(s)), and one or more logic units 720. In at least one embodiment, the computing device(s) 700 may comprise one or more virtual machines (VMs), and/or any of the components thereof may comprise virtual components (e.g., virtual hardware components). For non-limiting examples, one or more of the GPUs 708 may comprise one or more vGPUs, one or more of the CPUs 706 may comprise one or more vCPUs, and/or one or more of the logic units 720 may comprise one or more virtual logic units. As such, a computing device(s) 700 may include discrete components (e.g., a full GPU dedicated to the computing device 700), virtual components (e.g., a portion of a GPU dedicated to the computing device 700), or a combination thereof.

Although the various blocks of FIG. 7 are shown as connected via the interconnect system 702 with lines, this is not intended to be limiting and is for clarity only. For example, in some embodiments, a presentation component 718, such as a display device, may be considered an I/O component 714 (e.g., if the display is a touch screen). As another example, the CPUs 706 and/or GPUs 708 may include memory (e.g., the memory 704 may be representative of a storage device in addition to the memory of the GPUs 708, the CPUs 706, and/or other components). In other words, the computing device of FIG. 7 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 7.

The interconnect system 702 may represent one or more links or busses, such as an address bus, a data bus, a control bus, or a combination thereof. The interconnect system 702 may be arranged in various topologies, including but not limited to bus, star, ring, mesh, tree, or hybrid topologies. The interconnect system 702 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 706 may be directly connected to the memory 704. Further, the CPU 706 may be directly connected to the GPU 708. Where there is direct, or point-to-point connection between components, the interconnect system 702 may include a PCIe link to carry out the connection. In these examples, a PCI bus need not be included in the computing device 700.

The memory 704 may include any of a variety of computer-readable media. The computer-readable media may be any available media that may be accessed by the computing device 700. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 704 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 700. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 706 may be configured to execute at least some of the computer-readable instructions to control one or more components of the computing device 700 to perform one or more of the methods and/or processes described herein. The CPU(s) 706 may each include one or more cores (e.g., one, two, four, eight, twenty-eight, seventy-two, etc.) that are capable of handling a multitude of software threads simultaneously. The CPU(s) 706 may include any type of processor, and may include different types of processors depending on the type of computing device 700 implemented (e.g., processors with fewer cores for mobile devices and processors with more cores for servers). For example, depending on the type of computing device 700, the processor may be an Advanced RISC Machines (ARM) processor implemented using Reduced Instruction Set Computing (RISC) or an x86 processor implemented using Complex Instruction Set Computing (CISC). The computing device 700 may include one or more CPUs 706 in addition to one or more microprocessors or supplementary co-processors, such as math co-processors.

In addition to or alternatively from the CPU(s) 706, the GPU(s) 708 may be configured to execute at least some of the computer-readable instructions to control one or more components of the computing device 700 to perform one or more of the methods and/or processes described herein. One or more of the GPU(s) 708 may be an integrated GPU (e.g., with one or more of the CPU(s) 706 and/or one or more of the GPU(s) 708 may be a discrete GPU. In embodiments, one or more of the GPU(s) 708 may be a coprocessor of one or more of the CPU(s) 706. The GPU(s) 708 may be used by the computing device 700 to render graphics (e.g., 3D graphics) or perform general purpose computations. For example, the GPU(s) 708 may be used for General-Purpose computing on GPUs (GPGPU). The GPU(s) 708 may include hundreds or thousands of cores that are capable of handling hundreds or thousands of software threads simultaneously. The GPU(s) 708 may generate pixel data for output images in response to rendering commands (e.g., rendering commands from the CPU(s) 706 received via a host interface). The GPU(s) 708 may include graphics memory, such as display memory, for storing pixel data or any other suitable data, such as GPGPU data. The display memory may be included as part of the memory 704. The GPU(s) 708 may include two or more GPUs operating in parallel (e.g., via a link). The link may directly connect the GPUs (e.g., using NVLINK) or may connect the GPUs through a switch (e.g., using NVSwitch). When combined together, each GPU 708 may generate pixel data or GPGPU data for different portions of an output or for different outputs (e.g., a first GPU for a first image and a second GPU for a second image). Each GPU 708 may include its own memory, or may share memory with other GPUs.

In addition to or alternatively from the CPU(s) 706 and/or the GPU(s) 708, the logic unit(s) 720 may be configured to execute at least some of the computer-readable instructions to control one or more components of the computing device 700 to perform one or more of the methods and/or processes described herein. In embodiments, the CPU(s) 706, the GPU(s) 708, and/or the logic unit(s) 720 may discretely or jointly perform any combination of the methods, processes and/or portions thereof. One or more of the logic units 720 may be part of and/or integrated in one or more of the CPU(s) 706 and/or the GPU(s) 708 and/or one or more of the logic units 720 may be discrete components or otherwise external to the CPU(s) 706 and/or the GPU(s) 708. In embodiments, one or more of the logic units 720 may be a coprocessor of one or more of the CPU(s) 706 and/or one or more of the GPU(s) 708.

Examples of the logic unit(s) 720 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Image Processing Units (IPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 710 may include one or more receivers, transmitters, and/or transceivers that allow the computing device 700 to communicate with other computing devices via an electronic communication network, including wired and/or wireless communications. The communication interface 710 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 720 and/or communication interface 710 may include one or more data processing units (DPUs) to transmit data received over a network and/or through interconnect system 702 directly to (e.g., a memory of) one or more GPU(s) 708. In some embodiments, a plurality of computing devices 700 or components thereof, which may be similar or different to one another in various respects, can be communicatively coupled to transmit and receive data for performing various operations described herein, such as to facilitate latency reduction.

The I/O ports 712 may allow the computing device 700 to be logically coupled to other devices including the I/O components 714, the presentation component(s) 718, and/or other components, some of which may be built in to (e.g., integrated in) the computing device 700. Illustrative I/O components 714 include a microphone, mouse, keyboard, joystick, game pad, game controller, satellite dish, scanner, printer, wireless device, etc. The I/O components 714 may provide a natural user interface (NUI) that processes air gestures, voice, or other physiological inputs generated by a user. In some instances, inputs may be transmitted to an appropriate network element for further processing, such as to modify and register images. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 700. The computing device 700 may include depth cameras, such as stereoscopic camera systems, infrared camera systems, RGB camera systems, touchscreen technology, and combinations of these, for gesture detection and recognition. Additionally, the computing device 700 may include accelerometers or gyroscopes (e.g., as part of an inertia measurement unit (IMU)) that allow detection of motion. In some examples, the output of the accelerometers or gyroscopes may be used by the computing device 700 to render immersive augmented reality or virtual reality.

The power supply 716 may include a hard-wired power supply, a battery power supply, or a combination thereof. The power supply 716 may provide power to the computing device 700 to allow the components of the computing device 700 to operate.

The presentation component(s) 718 may include a display (e.g., a monitor, a touch screen, a television screen, a heads-up-display (HUD), other display types, or a combination thereof), speakers, and/or other presentation components. The presentation component(s) 718 may receive data from other components (e.g., the GPU(s) 708, the CPU(s) 706, DPUs, etc.), and output the data (e.g., as an image, video, sound, etc.).

### Example Data Center

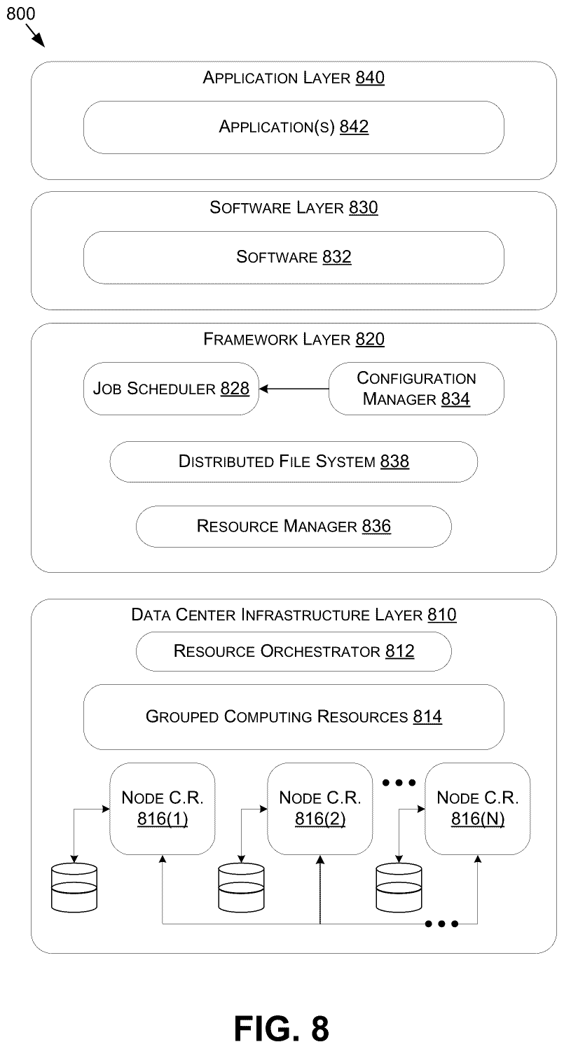

FIG. 8 illustrates an example data center 800 that may be used in at least one embodiments of the present disclosure, such as to implement the systems 100, 200, or in one or more examples of the data center 800. The data center 800 may include a data center infrastructure layer 810, a framework layer 820, a software layer 830, and/or an application layer 840.

As shown in FIG. 8, the data center infrastructure layer 810 may include a resource orchestrator 812, grouped computing resources 814, and node computing resources (“node C.R.s”) 816(1)-1316(N), where “N” represents any whole, positive integer. In at least one embodiment, node C.R.s 816(1)-1316(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 816(1)-1316(N) may correspond to a server having one or more of the above-mentioned computing resources. In addition, in some embodiments, the node C.R.s 816(1)-13161(N) may include one or more virtual components, such as vGPUs, vCPUs, and/or the like, and/or one or more of the node C.R.s 816(1)-1316(N) may correspond to a virtual machine (VM).

In at least one embodiment, grouped computing resources 814 may include separate groupings of node C.R.s 816 housed within one or more racks (not shown), or many racks housed in data centers at various geographical locations (also not shown). Separate groupings of node C.R.s 816 within grouped computing resources 814 may include grouped compute, network, memory or storage resources that may be configured or allocated to support one or more workloads. In at least one embodiment, several node C.R.s 816 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 812 may configure or otherwise control one or more node C.R.s 816(1)-1316(N) and/or grouped computing resources 814. In at least one embodiment, resource orchestrator 812 may include a software design infrastructure (SDI) management entity for the data center 800. The resource orchestrator 812 may include hardware, software, or some combination thereof.

In at least one embodiment, as shown in FIG. 8, framework layer 820 may include a job scheduler 828, a configuration manager 834, a resource manager 836, and/or a distributed file system 838. The framework layer 820 may include a framework to support software 832 of software layer 830 and/or one or more application(s) 842 of application layer 840. The software 832 or application(s) 842 may respectively include web-based service software or applications, such as those provided by Amazon Web Services, Google Cloud and Microsoft Azure. The framework layer 820 may be, but is not limited to, a type of free and open-source software web application framework such as Apache Spark™ (hereinafter “Spark”) that may utilize distributed file system 838 for large-scale data processing (e.g., “big data”). In at least one embodiment, job scheduler 828 may include a Spark driver to facilitate scheduling of workloads supported by various layers of data center 800. The configuration manager 834 may be capable of configuring different layers such as software layer 830 and framework layer 820 including Spark and distributed file system 838 for supporting large-scale data processing. The resource manager 836 may be capable of managing clustered or grouped computing resources mapped to or allocated for support of distributed file system 838 and job scheduler 828. In at least one embodiment, clustered or grouped computing resources may include grouped computing resource 814 at data center infrastructure layer 810. The resource manager 836 may coordinate with resource orchestrator 812 to manage these mapped or allocated computing resources.

In at least one embodiment, software 832 included in software layer 830 may include software used by at least portions of node C.R.s 816(1)-1316(N), grouped computing resources 814, and/or distributed file system 838 of framework layer 820. One or more types of software may include, but are not limited to, Internet web page search software, e-mail virus scan software, database software, and streaming video content software.

In at least one embodiment, application(s) 842 included in application layer 840 may include one or more types of applications used by at least portions of node C.R.s 816(1)-1316(N), grouped computing resources 814, and/or distributed file system 838 of framework layer 820. One or more types of applications may include, but are not limited to, any number of a genomics application, a cognitive compute, and a machine-learning application, including updating/training or inferencing software, machine-learning framework software (e.g., PyTorch, TensorFlow, Caffe, etc.), and/or other machine-learning applications used in conjunction with one or more embodiments.

In at least one embodiment, any of configuration manager 834, resource manager 836, and resource orchestrator 812 may implement any number and type of self-modifying actions based at least on any amount and type of data acquired in any technically feasible fashion. Self-modifying actions may relieve a data center operator of data center 800 from making possibly bad configuration decisions and possibly avoiding underutilized and/or poor performing portions of a data center.

The data center 800 may include tools, services, software or other resources to update/train one or more machine-learning models (e.g., using the datasets 218 generated according to the techniques described herein, etc.) or predict or infer information using one or more machine-learning models according to one or more embodiments described herein. For example, a machine-learning model(s) may be updated/trained by calculating weight parameters according to a neural network architecture using software and/or computing resources described above with respect to the data center 800. In at least one embodiment, trained or deployed machine-learning models corresponding to one or more neural networks may be used to infer or predict information using resources described above with respect to the data center 800 by using weight parameters calculated through one or more training techniques, such as but not limited to those described herein.

In at least one embodiment, the data center 800 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to update/train or perform inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 1200 of FIG. 12—e.g., each device may include similar components, features, and/or functionality of the computing device(s) 1200. In addition, where backend devices (e.g., servers, NAS, etc.) are implemented, the backend devices may be included as part of a data center 1300, an example of which is described in more detail herein with respect to FIG. 13.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 1200 described herein with respect to FIG. 12. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. A processor comprising:
one or more circuits to:
receive a configuration that specifies randomization for a semantic layer of a model for a scene;
sample a distribution according to the randomization to select data for the semantic layer of the model;
generate the scene including the model having the data selected for the semantic layer; and
render the scene including the model to generate an image for updating a neural network.

2. The processor of claim 1, wherein the one or more circuits are to:
generate the scene to include an environmental model; and
position the model within the environmental model according to the configuration.

3. The processor of claim 1, wherein the one or more circuits are to:
update a position of the model in the scene according to a simulation of one or more physical constraints.

4. The processor of claim 3, wherein the model is a first model, the scene is generated to include a second model, and the one or more circuits are to:
simulate a collision between the first model and the second model.

5. The processor of claim 1, wherein the data selected for the semantic layer of the model comprises at least one of a color, a pattern, a texture, or a material.

6. The processor of claim 1, wherein the one or more circuits are to generate a label for the image based at least on an aspect of the model within the scene.

7. The processor of claim 1, wherein the one or more circuits are to determine a pose for the model according to the configuration.

8. The processor of claim 7, wherein the one or more circuits are to determine the pose by simulating an animation selected for the model according to the configuration.

9. The processor of claim 1, wherein the one or more circuits are to position the model within the scene relative to a viewpoint used to generate the image.

10. The processor of claim 1, wherein the one or more circuits are to:
generate a plurality of scenes according to the configuration;
generate a plurality of images using the plurality of scenes; and
filter the plurality of images based at least on an illumination of the plurality of scenes or a placement of models within the plurality of scenes.

11. The processor of claim 1, wherein the processor is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system implemented using an edge device;
a system implemented using a robot;
a system for performing conversational AI operations;
a system for performing generative AI operations using a large language model (LLM);
a system for generating synthetic data;
a system incorporating one or more virtual machines (VMs);
a system implemented at least partially in a data center; or
a system implemented at least partially using cloud computing resources.

12. A processor comprising:
one or more circuits to:
generate a synthetic scene including a plurality of models positioned according to a configuration file, at least one model of the plurality of models comprising a semantic layer having a property randomized according to a distribution specified in the configuration file; and
simulate movement of the at least one model within the synthetic scene; and
render the synthetic scene to generate an image for updating a neural network.

13. The processor of claim 12, wherein the one or more circuits are to simulate movement of the at least one model by simulating a gravitational force within the synthetic scene.

14. The processor of claim 12, wherein the one or more circuits are to simulate movement of the at least one model by simulating a collision between the at least one model and a second model of the plurality of models within the synthetic scene.

15. The processor of claim 12, wherein the one or more circuits are to simulate movement of the at least one model by adjusting the at least one model according to an animation.

16. The processor of claim 15, wherein the one or more circuits are to select an animation frame of the animation according to the configuration file.

17. The processor of claim 12, wherein the processor is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system implemented using an edge device;
a system implemented using a robot;
a system for performing conversational AI operations;
a system for performing generative AI operations using a large language model (LLM);
a system for generating synthetic data;
a system incorporating one or more virtual machines (VMs);
a system implemented at least partially in a data center; or
a system implemented at least partially using cloud computing resources.

18. A method, comprising:
receiving a configuration that specifies randomization for a semantic layer of a model for a scene;
sampling, using one or more processors, a distribution according to the randomization to select data for the semantic layer of the model;
generating, using the one or more processors, the scene including the model having the data selected for the semantic layer; and
rendering, using the one or more processors, the scene including the model to generate an image for updating a neural network.

19. The method of claim 18, further comprising:
generating, using the one or more processors, the scene to include an environmental model; and
positioning, using the one or more processors, the model within the environmental model according to the configuration.

20. The method of claim 19, further comprising updating, by using the one or more processors, a position of the model in the scene according to a physical simulation.
